(19) United States
(12) Patent Application Publication
(10) Pub. No.: US 2008/0280170 A1
(43) Pub. Date: Nov. 13, 2008

(54) Method for Operating an Electrochemical Cell and a Cassette for Use Therewith

(76) Inventor: Donald James Highgate, Surrey (GB)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 11/908,568

(22) PCT Filed: Mar. 16, 2006
(86) PCT No.: PCT/GB2006/000958

§ 371 Date: May 12, 2008

(30) Foreign Application Priority Data
Mar. 16, 2005 (GB) 0505284.0
Mar. 6, 2006 (GB) 0604464.8

(51) Int. Cl. H01M 8/00

(52) U.S. Cl. 429/13

(57) ABSTRACT

A method for operating an electrochemical cell, comprises supplying reaction material from a first compartment of, and collecting a reaction product or unreacted material in a second compartment of, a cassette connected to the cell, and controlling the flow of the reaction material and/or of the reaction product/unreacted material. A cassette (1) suitable for use in such a method contains a moveable member (2) and a compartment (3, 4, 5, 6) on each side of the moveable member, and comprises also ports (7, 8, 9, 10) for fluid corresponding to each compartment, wherein the compartments can be respectively expanded and compressed by movement of the member. Such a cassette can be used in connection with a membrane (14) in a cell (13).

### FIELD OF THE INVENTION

This invention relates to a method for operating an electrochemical cell and a cassette for use therewith.

### BACKGROUND TO THE INVENTION

Fuel cells convert a fuel and an oxidant into electricity and chemical products within a two-chamber electrochemical cell. The product electricity may be used to power a variety of devices. Traditionally, fuel cells have employed gaseous H₂ and O₂ which are delivered to the anode and cathode chamber and are exhausted, resulting in significant changes in volume. Depending on the mode of operation, some of the gas provided may remain unreacted.

Recent developments include those described in International Patent Application No. PCT/GB2005/003644. For example, doped fuels allow fuel cells employing a liquid fuel and/or a liquid oxidant, e.g. NaBH₄ and H₂O₂ respectively. Such liquids change chemically during the electrochemical reaction but do not alter significantly in volume. That Application also describes a method of determining when a liquid has expired, based on colour change. The advantages of dual liquid systems include: the ability to operate underwater in marine devices; freedom from performance degradation associated with low oxygen levels at high altitude; and avoidance of chemical poisoning from atmospheric pollutants including CO and SOₓ.

### SUMMARY OF THE INVENTION

The present invention is based on the realisation that not only does refuelling of an electrochemical cell require delivery of reaction material such as fuel and oxidant, but also that there is a need to remove unreacted and/or spent substances, e.g. waste products of the combustion reaction, from the cell.

According to one aspect of the present invention, an electrochemical cell is operated in connection with a cassette having respective compartments for reaction material and for a reaction product and/or unreacted material. Means is provided to control flow of one or both of the input and output materials, between the cell and the cassette.

The invention allows controlled use of fuel/oxidant or other reaction materials and also controlled collection of spent material. The cassette may be connected to the cell via the appropriate number of lines for the materials that are required for operation and use, and these lines may be closed or open, e.g. using suitable valves, thereby allowing one cassette to be removed and replaced by another.

According to a further aspect of the present invention, a cassette contains a moveable member and compartments on each side of the moveable member, and comprises also ports for fluid corresponding to each compartment, whereby each compartment can be expanded or compressed by movement of the member. By compressing a compartment containing reaction material, or a pair of subcompartments, e.g. respectively containing fuel and oxidant, such material is transferred to the cell. In addition, removal of unreacted material or the waste products of the reaction may be achieved, e.g. by expansion of the other compartment in the cassette.

### BRIEF DESCRIPTION OF THE DRAWINGS

FIGS. 1(a) and 1(b) are schematic side and top views of a cassette and fuel cell/electrolyser, embodying the present invention.

### DESCRIPTION OF THE PREFERRED EMBODIMENTS

The particular embodiment of the invention shown in the drawings comprises a cassette 1 containing, and in sealing conjunction therewith, a sliding member 2. On one side of the member 2 are subcompartments 3 and 4, for fuel and oxidant respectively. On the other side of the member 2 are subcompartments 5 and 6, for spent fuel and spent oxidant respectively. The subcompartments 3, 4, 5 and 6 are each associated with a port, i.e. respective ports 7, 8, 9 and 10 (with intended flow direction indicated by an arrow). The subcompartments are divided such that subcompartments 3 and 4 are compressed when the member 2 is driven in the direction shown by the arrow, thereby expelling fuel and oxidant through the ports 7 and 8. At the same time, the subcompartments 9 and 10 can expand to accommodate spent fuel and spent oxidant through the respective ports 9 and 10. A seal should be maintained between the sliding member 2 and the inside of the cassette 1.

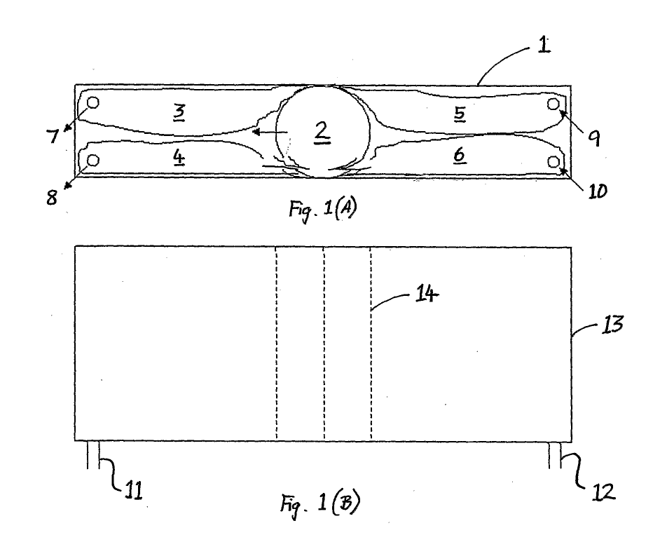

The ports 7, 8, 9 and 10 are in connection with corresponding ports 11 and 12 (two only shown) in an electrochemical cell 13 containing a membrane assembly 14 shown in outline in FIG. 1(b). The delivery of fuel and oxidant to the cell allows the desired reaction to take place, e.g. with the production of electricity which can be removed (by known means, not shown). Spent fuel and oxidant may be transferred to the cassette.

While the specific embodiment shown in the drawings illustrates the principles behind the invention, the invention is in no sense limited to the details of that embodiment. As will now be described, a variety of possibilities is consistent with the general principle of the present invention. Much will depend on the choice of reaction materials and the nature of the reaction that occurs in the cell.

A cassette of the present invention may comprise one compartment or a pair of compartments on each side, e.g. of a moveable member. Each compartment or subcompartment on one side may contain a fuel or an oxidant. Each compartment or subcompartment on the other side may contain spent fuel or spent oxidant. Such spent substances may be the by-products of combustion of liquid reaction material, conducted within the electrochemical cell.

In an embodiment of the present invention, the cassette is connected to an electrochemical cell via valved ports for fluid corresponding to each compartment or subcompartment within the cassette. The port or ports corresponding to one side of the cassette may be configured to only allow movement of fluid from the cassette to the electrochemical cell, and the port or ports corresponding to the other side of the cassette may be configured to only allow movement of fluid from the electrochemical cell to the cassette. It will be understood that there will be as many independent conduits between cassette and cell as are necessary to allow the components to pass between them without reaction. Typically, one material is supplied to one side of a membrane in the cell and a second material to the other.

In a preferred embodiment, the refuelling cassette may be constructed from a rigid material such as Perspex. Preferably, the compartments containing the fuel and/or the oxidant are made of a flexible material such as polyethylene. The member preferably forms an airtight seal with the edges of the refuelling cassette, to prevent leakage or mixing of new and spent fuels and/or oxidants.

Movement of the member within the cassette may be manually or automatically operated, e.g. it may be driven by a motor or spring. Alternatively, it may be pressure-dependent, e.g. if it is a gas device, as the fuel and oxidant become used, the respective pressures in the subcompartments drop, and this could be used to trigger, at a certain level, the release of a pressure-dependent valve on the cassette which opens and allows the cassette to release new fuel and oxidant to the cell. Such an arrangement has the advantage of there being no moving mechanism. Further possibilities include mechanism triggered by intelligent feedback from the apparatus, e.g. in response to a voltage, power or pressure change, e.g. a drop, below a pre-determined level.

As indicated in the drawing, a moveable member may roll. This may be pushed or pulled, manually or automatically, e.g. in response to manual or triggered start mechanism. Alternatives to such rolling members include pistons or plungers that can be pushed or pulled. A further alternative is a rocking member that in one sense compresses a compartment and in the opposite sense allows that compartment to expand and compresses another.

In general, use of the cassette is designed to allow one compartment or pair of subcompartments to be compressed. The expulsion of reactant material may be associated directly with the drawing in of spent material, one compartment undergoing compression while the other undergoes expansion. Expulsion of, say, fuel and oxidant from the cassette to the cell may cause spent fuel and/or oxidant to be drawn into the respective compartments within the cassette. For example, a decease in pressure within the expanding compartment may cause spent material to be drawn into the other compartments, or increased pressure in the cassette from the introduction of new reactant material may cause spent material to be received in the cassette.

The refuelling device may be used in two different methods. In a first method, the cassette is connected to the electrochemical cell when it is essentially spent, and therefore needs re-charging. The cassette can be used as a source of new fuel and/or oxidant to the cell and to receive spent fuel and/or oxidant. The cassette may be used for a single fuel and/or oxidant replacement or multiple replacements, by means of a stepped or graduated slide mechanism.

A second method involves the cassette being connected to the electrochemical cell while the cell is being used, the cassette then providing a source of new fuel and/or oxidant, and receiving spent fuel and/or oxidant. When refuelling is required, a new cassette is used.

The cassette may be used to deliver and collect fuel and oxidant in equal quantities. It may also be used when the fuel and oxidant are required in fixed, but different, ratios.

The fuel may be a liquid or gas. Examples of fuels include methanol, ethanol, sodium borohydride and hydrogen.

The oxidant may be a liquid or gas. Examples of oxidants include potassium permanganate, hydrogen peroxide and oxygen. Oxygen may be provided in the form of air.

In one embodiment, the invention utilises liquid reaction material, e.g. liquid fuel and liquid oxidant. These may give corresponding spent liquids. The system therefore has an essentially constant volume of liquid. When the fuel and oxidant have been exhausted, the cassette (containing essentially only spent material) may be removed and replaced.

In another embodiment, the reaction material is gaseous, e.g. gaseous fuel and gaseous oxidant. The cassette is preferably adapted to provide them in a fixed ratio. For example, hydrogen may be consumed while the nitrogen in air as the oxidant remains unused and is collected in the cassette. Such a system will not comprise a constant volume of gas, and this can be compensated by appropriate pressure control.

If, say, oxygen and hydrogen are used as the reaction material, the cell may be run open-ended, so that not all of the supplied material is consumed. Unreacted material is collected in the cassette and, since the volume of material is not constant, pressure control will be required. Collected unreacted material may be recycled by reversing the direction of the moveable member in the cassette.

As indicated above, a cassette may be provided in which two reaction components are provided in a fixed ratio. It may be preferred that one is in excess, so that a relatively safe material (e.g; oxygen) is left when the other (e.g. hydrogen) is consumed.

1. A method for operating an electrochemical cell, which comprises supplying reaction material from a first compartment of, and collecting a reaction product or unreacted material in a second compartment of, a cassette connected to the cell, and controlling the flow of the reaction material and/or of the reaction product/unreacted material.

2. The method according to claim 1, wherein the controlling means comprises a valve.

3. The method according to claim 1, wherein the cassette comprises a member that is moveable therewithin, thereby changing the respective volumes of the compartments.

4. The method according to claim 1, wherein the first compartment comprises two subcompartments, for respective reaction materials.

5. The method according to claim 1, wherein the second compartment comprises two subcompartments.

6. The method according to claim 1 wherein the first compartment, or a subcompartment thereof, contains fuel.

7. The method according to claim 1, wherein the first compartment, or another subcompartment thereof, contains oxidant.

8. The method according to claim 1, wherein the reaction material is liquid.

9. The method according to claim 1, wherein the reaction material is gaseous.

10-18. (canceled)

19. A method for operating an electrochemical cell, which comprises supplying reactants respectively from a pair of subcompartments in a first compartment of a cassette connected to the cell, one of the reactants being an oxidant that is in excess with respect to the other reactant; collecting a reaction product or unreacted reactant in a second compartment of the cassette; and controlling the flow of the reactants and/or the reaction product/unreacted reactant.
